(19) United States
(12) Patent Application Publication
(10) Pub. No.: US 2013/0208080 A1
(43) Pub. Date: Aug. 15, 2013

(54) SYSTEMS, METHODS, AND DEVICES FOR ADJUSTING VIDEO CONFERENCE PARAMETERS TO MAINTAIN SYSTEM PERFORMANCE

(71) Applicants: Derek Lukasik, Fort Collins, CO (US); Byron A. Alcorn, Fort Collins, CO (US)

(72) Inventors: Derek Lukasik, Fort Collins, CO (US); Byron A. Alcorn, Fort Collins, CO (US)

(73) Assignee: Hewlett-Packard Development Company, L.P., Fort Collins, CO (US)

(21) Appl. No.: 13/880,371

(22) PCT Filed: Oct. 25, 2010
(86) PCT No.: PCT/US10/53963

§ 371 Date: Apr. 18, 2013

(51) Int. Cl. H04N 7/26; H04N 7/15

(52) U.S. Cl. CPC H04N 19/00012; H04N 7/152
USPC 348/14.09; 375/240.02

(57) ABSTRACT

Systems, methods, and devices for adapting video parameters during a video conference to maintain system performance are provided. One such device may include data processing circuitry (28) that compresses first video data using first processing parameters, decompresses second video data compressed by a second electronic device (12) using second processing parameters, measures a load on the data processing circuitry (28), and, when the load on the data processing circuitry (28) approaches a load that is expected to cause overloading, prevents such overloading by selectively either adjusting the first processing parameters or issuing a request to the second electronic device (12) to adjust the second processing parameters, or both adjusting the first processing parameters and issuing the request to the second electronic device (12), causing the load on the data processing circuitry (28) to decrease.

### BACKGROUND

Video conferencing provides an effective and inexpensive way to hold meetings with remote participants. The conferees may connect to one another over a network, exchanging streaming audio and video streams, which may displayed at each respective conferencing device. To create the outgoing video stream, a conferencing device may obtain video from a camera. Because transmitting the raw video data from the camera could require excessive bandwidth, this raw video data first may be compressed. Compression of the video data may be significantly resource-intensive. Likewise, when such compressed media streams are received from other conferencing devices, the receiving conferencing device first must decompress this media data before it may be displayed. Decompression also may be resource-intensive, albeit less so than compression.

Conventionally, video conferencing devices may become overloaded when compression and/or decompression of the exchanged video streams consumes more resources than the video conferencing device can provide. Under such conditions, the video conferencing device may respond erratically and/or may drop frames of the video data. As video conferencing devices increasingly support greater mufti-way conferencing, which involves decompressing a greater number of incoming video streams, resource usage may increase.

### BRIEF DESCRIPTION OF DRAWINGS

FIG. 1 is a perspective view of a video conferencing system, which may adjust video conferencing parameters to maintain a reasonable system bad, in accordance with an embodiment;

FIG. 2 is a block diagram of the video conferencing system of FIG. 1, in accordance with an embodiment;

FIG. 3 is a parameter diagram representing various video compression parameters that may be adjusted to maintain a reasonable system bad during a video conference, in accordance with an embodiment;

FIG. 4 is a flowchart describing an embodiment of a method for managing resource usage during a video conference to maintain a reasonable system bad; and

FIG. 5 is a flowchart describing an embodiment of a method for initializing video conference parameters to maintain a reasonable system load when a new conferee joins a video conference.

### DETAILED DESCRIPTION

Since compressing and decompressing media streams exchanged during a video conference could overload a video conferencing device, the present disclosure relates to techniques for adjusting the compression parameters of both the outgoing media streams being compressed and the incoming media streams being decompressed. In particular, some embodiments involve a video conferencing device that monitors its available resources (e.g., processor load, available memory, available storage, battery life, and so forth). If excessive resource usage occurs, the performance of the video conferencing device could suffer. Thus, depending on the extent of the resource usage of the video conferencing device, the video conferencing device may adjust certain compression parameters (e.g., resolution, frame rate, quality parameter, enhancement layers, and so forth) to reduce the processing intensity of compressing an outgoing media stream, or the video conferencing device may issue a request to other video conferencing devices to adjust certain compression parameters so as to reduce the processing intensity of decompressing incoming media streams from these other video conferencing devices. Adjusting the compression of the outgoing media streams may result in a more significant change in video conference device resource usage, and thus may be understood to represent a “coarse adjustment.” Requesting the adjustment of the compression of the incoming media streams may result in a less significant change in video conference device resource usage, depending on the number of incoming media streams are being decompressed, and thus may be understood to represent a “fine adjustment.”

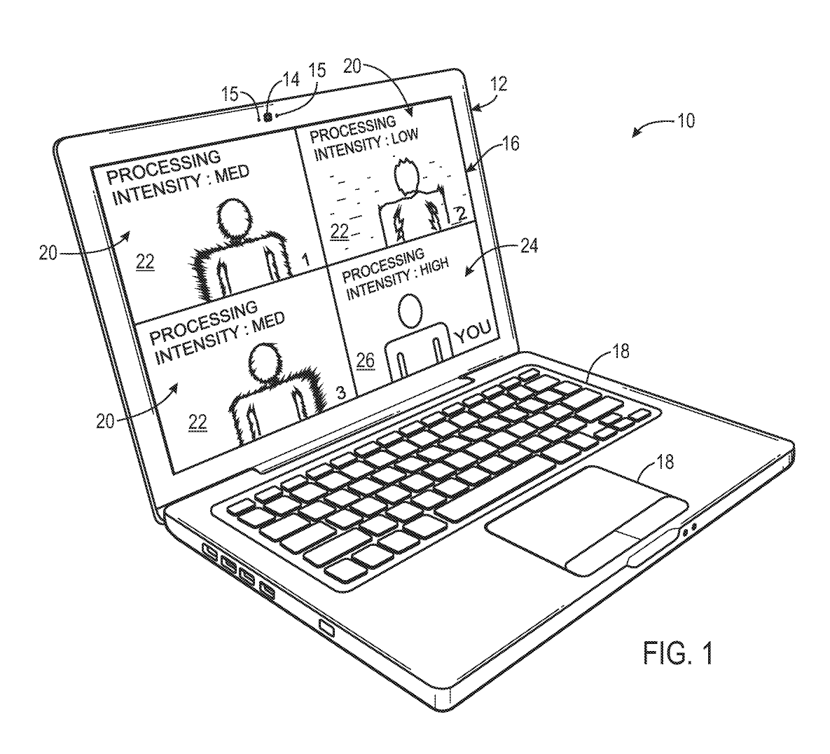

With the foregoing in mind, FIG. 1 represents a video conferencing system 10 capable of adjusting various video conferencing parameters (e.g., resolution, frame rate, quality parameter, enhancement layers, and so forth) to maintain a reasonable system load. Thus, the video conferencing system 10 may be more likely to maintain satisfactory operation throughout a video conference. The video conferencing system 10 may involve any suitable number of video conferencing devices 12. The video conference device 12 shown in FIG. 1 is represented as a notebook computer by Hewlett-Packard Company. However, in other embodiments, the video conferencing device 12 may be any suitable device capable of performing the techniques disclosed herein, such as a desktop computer, a workstation, a handheld device (e.g., a portable phone), or a tablet computer, to name a few examples.

A camera 14 of the video conferencing device 12 may obtain video conference video data and a microphone 15 may record video conference audio data. In some embodiments, video conference audio may be obtained by a separate telephone and the video conferencing device 12 may obtain only video. An electronic display 16 of the video conferencing device 12 may display video data associated with a video conference that may take place using the video conference device 12. In addition to the camera 14 and microphone 15, a user may interact with the video conferencing device 12 via various input structures 18, such as a keyboard and/or a track pad or mouse.

When a video conference is occurring, the video conferencing device 12 may display on the display 16 various incoming media streams 20 from other video conferencing devices 12. The particular characteristics of the incoming media streams 20 may vary depending on the other conferees and the other video conferencing devices 12 used by the other conferees. For example, some of the incoming media streams 20 may have been compressed using parameters that result in a relatively lower or higher processing intensity 22 when decompressed by the video conference device 12. The differences in processing intensity 22 may be reflected as a difference in quality or bandwidth, for example. As will be discussed below, the incoming media streams 20 may be encoded in any suitable format given available bandwidth and the capabilities of the other video conferencing devices 12 taking part in the video conference. In some embodiments, the incoming media streams 20 may be encoded in an H.264 format.

When the available resources of the video conferencing device 12 become limited slightly, the video conferencing device 12 may issue a request to the other conferees to provide incoming media streams 20 of sufficiently low processing intensity 22 to preserve the system performance of the video conferencing device 12 when decompressed by the video conferencing device 12. The resulting incoming media streams 20 may have a lower resolution or frame rate, or may have been compressed using fewer enhancement layers or with a higher quality parameter (although compression with a higher quality parameter may result in an incoming media stream 20 of higher bandwidth). When the video conferencing device 12 decompresses incoming media streams 20 with lower processing intensities 22, the video conferencing device may consume fewer of its available resources. Requesting the adjustment of the compression of the incoming media streams 20 may result in a relatively slight change in video conference device resource usage, depending on the number of incoming media streams are being decompressed, and thus may be understood to represent a “fine adjustment.”

In some embodiments, an outgoing media stream 24 also may be displayed on the display 16. Depending on the parameters used to compress the outgoing media stream 24, compression of the outgoing media stream 24 may involve a processing intensity 26. The difference in processing intensity 26 may be reflected as a difference in quality or bandwidth, for example. The outgoing media stream 24 may be encoded in any suitable format given available bandwidth and the capabilities of the other video conferencing devices 12 taking part in the video conference. In some embodiments, the outgoing media stream 24 may be encoded in an H.264 format.

When the available resources of the video conferencing device 12 become limited relatively significantly, the video conferencing device 12 may adjust the compression parameters of the outgoing media stream 24 to preserve the system performance of the video conferencing device 12, since compression may require relatively significant processing resources. The resulting outgoing media stream 24 may have a lower resolution or frame rate, or may have been compressed using fewer enhancement layers or with a higher quality parameter (although compression with a higher quality parameter may result in an outgoing media stream 24 of higher bandwidth). Adjusting the compression of the outgoing media streams may result in a more significant change in video conference device resource usage, and thus may be understood to represent a “coarse adjustment.”

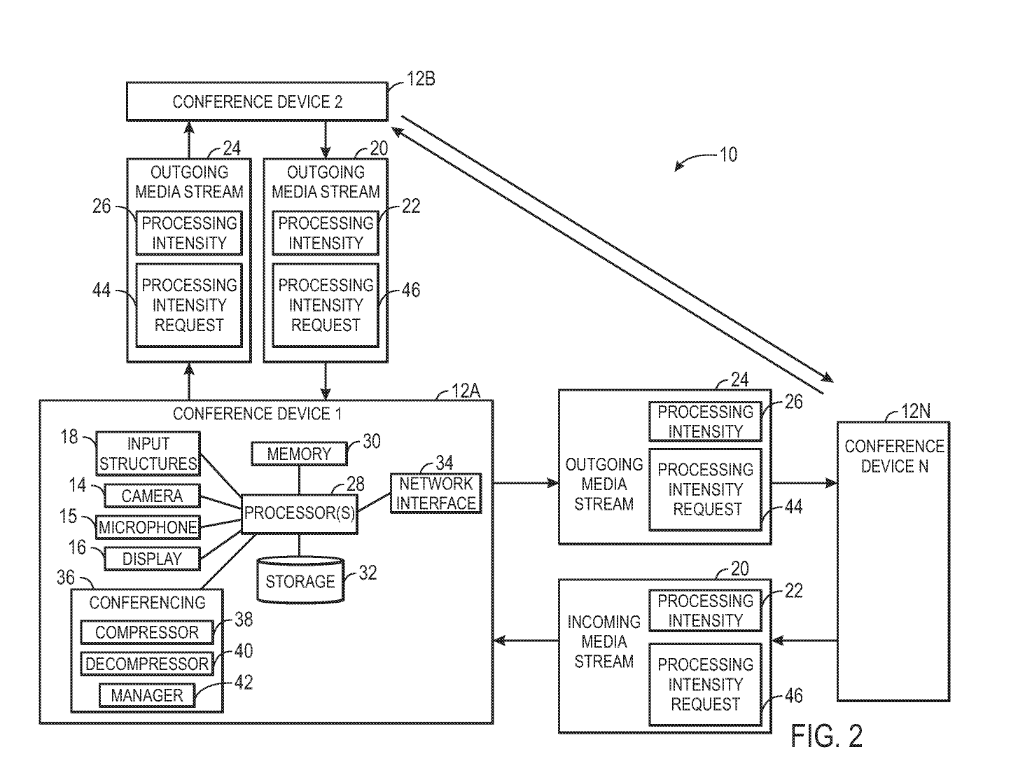

A block diagram of the video conferencing system 10 appears in FIG. 2. As shown in FIG. 2, the video conferencing system 10 may include any suitable number of video conferencing devices 12, shown as video conferencing devices 12A, 12B . . . 12N, in communication with one another through a network. In some embodiments, the video conferencing devices 12 may communicate in a peer-to-peer arrangement, as shown, while other embodiments may involve a central control server (not shown). Each video conferencing device 12 may include the components represented in the video conferencing device 12A labeled “Conference Device 1”. The various functional blocks of the video conferencing devices 12 may include hardware elements, software elements, or a combination of both. The blocks of the video conferencing device 12A illustrated in FIG. 2 are intended to represent only one example of a particular implementation of a video conferencing device 12 and are intended to illustrate the types of components that may be present in a video conferencing device 12.

Among other things, the video conferencing devices 12 may include the camera 14, microphone 15, display 16, and suitable input structures 18, as discussed above with reference to FIG. 1. The camera 14 may obtain video data of any suitable resolution and frame rate. In some embodiments, the camera 14 may obtain high definition (HD) video of 1280×720 pixels and approximately 30 or 60 frames per second (FPS), as well as lower resolutions and frame rates. As should be appreciated, some embodiments of the camera 14 may obtain higher resolution and/or higher-frame-rate video data. The microphone 15 may obtain monaural or stereo audio data. The display 16 may be any suitable electronic display, such as a liquid crystal display (LCD). In some embodiments, the display 16 may be a touch screen that functions as one of the input structures 18. As noted above, the input structures 18 may be, for example, a keyboard, a mouse, a track pad, hardware buttons, and so forth, to enable a user to interface with the video conferencing device 12.

Processor(s) 28 and/or other data processing circuitry may be operably coupled to memory 30 and storage 32 to perform various algorithms for carrying out the presently disclosed techniques. These algorithms may be encoded in programs and/or instructions that may be executed by the processor(s) 28 and stored in any suitable article of manufacturer that includes one or more tangible, computer-readable media at least collectively storing the instructions or routines, such as the memory 30 and/or the storage 32. By way of example, the memory 30 and the storage 32 may include any suitable articles of manufacture for storing data and executable instructions, such as random-access memory, read-only memory, rewriteable flash memory, hard drives, and optical disks. The network interface 34 may provide communication via a personal area network (PAN) (e.g., Bluetooth), a local area network (LAN) (e.g., Wi-Fi), and/or wide area network (WAN) (e.g., 3G or LTE).

The video conferencing device 12 also may include a video conferencing component 36 that may be implemented using hardware or machine readable instructions running on the processor(s) 28, or some combination thereof. The video conferencing component 36 may allow one video conferencing device 12 (e.g., the video conferencing device 12A) to carry out a video conference with other video conferencing devices 12 (e.g., the video conferencing devices 12B and 12N). In general, the video conferencing component 36 may include a compressor component 38 to compress the outgoing media streams 24, a decompressor component 40 to decompress the incoming media streams 20, and a resource manager component 42 to prevent system overloading due to excessive resource consumption by the compressor component 38 or decompressor component 40. In some embodiments, the components 38-42 of the video conferencing component 36 represent machine readable instructions running on the processor(s) 28. In other embodiments, the compressor component 38 or the decompressor component 40 may represent hardware encoders or decoders.

The compressor component 38 may compress raw video data obtained by the camera 14 into a compressed and encoded form that may require significantly less bandwidth than uncompressed video data. By way of example, the compressor component 38 may be a hardware or software component that encodes raw video data using an H.264 format (e.g., SBC H.264 encoding). The encoded compressed video data may be output as the outgoing media stream 24. Likewise, the incoming media streams 20 may include video encoded according to an encoding protocol such as H.264, which must be decompressed to be displayed. The decompressor component 40 of the video conferencing component 36 may decode and decompress the incoming media streams 20.

The device resources (e.g., processing resources, memory resources, power, network bandwidth, etc.) required of the video conferencing device 12 to compress the outgoing video stream 24 via the compressor component 38 and to compress the incoming media streams 20 via the decompressor component 40 may require substantial device resources. Compressing the outgoing media stream 24 via the compressor component 38 may require more resources, in general, than decompressing one of the incoming media streams 20 via the decompressor component 40. Indeed, in some embodiments, decompression via the decompressor component 40 may require approximately ¼ the processing resources per incoming media stream 20 than compressing the outgoing media stream 24 via the compressor component 38. Depending on the number of video conferencing devices 12 participating a video conference, the resources required for decompression via the decompressor component 40 may approach or exceed the resources required for compression via the compressor component 38.

Since a video conferencing device 12 may operate erratically if the resources of the video conferencing device 12 are overused, the resource manager component 42 of the video conferencing component 36 may adjust the compression and decompression undertaken respectively by the compressor component 38 and the decompressor component 40. To adjust the compression undertaken by the compressor component 38, the resource manager component 42 may adjust various compression parameters (e.g., resolution, frame rate, quality parameter, enhancement layers, and so forth), as will be described in below. Adjusting the compression of the compressor component 38, which may output encoded compressed video data for the outgoing media stream 24, may substantially impact the processing intensity 26 of compressing the video data of the outgoing media stream 24. Thus, adjusting the compression parameters may be understood to represent a “coarse adjustment” of the processing intensity 26, increasing or decreasing the resource usage of the video conferencing component 36 in the video conferencing device 12.

To adjust the processing intensity of the decompression undertaken by the decompressor component 40, the resource manager component 42 may communicate an incoming processing intensity request 44 to other video conferencing devices 12 in the video conferencing system 10. In response, the other video conferencing devices 12 may provide an incoming media stream 20 having a lower (or higher) processing intensity 22, allowing the incoming media stream 20 to be decompressed by the decompressor component 40 using fewer (or more) resources. For example, the incoming media streams 20 may have a lower frame rate or resolution, may be compressed using fewer enhancement layers, or may have less compression but require greater network bandwidth.

Likewise, other video conferencing devices 12 (e.g., video conferencing device 12B) may provide similar outgoing processing intensity requests 46 requesting that the outgoing media stream 24 have a lower (or higher) processing intensity 26. In response to an outgoing processing intensity request 46, the video conferencing device 12A may output an outgoing media stream 24 having a lower (or higher) processing intensity 26. In some embodiments, the video conferencing device 12A may output different respective outgoing media streams 24 to other video conferencing devices 12. That is, different outgoing media streams 24 may have different processing intensities 26 that vary depending on the receipt of outgoing processing intensity requests 46.

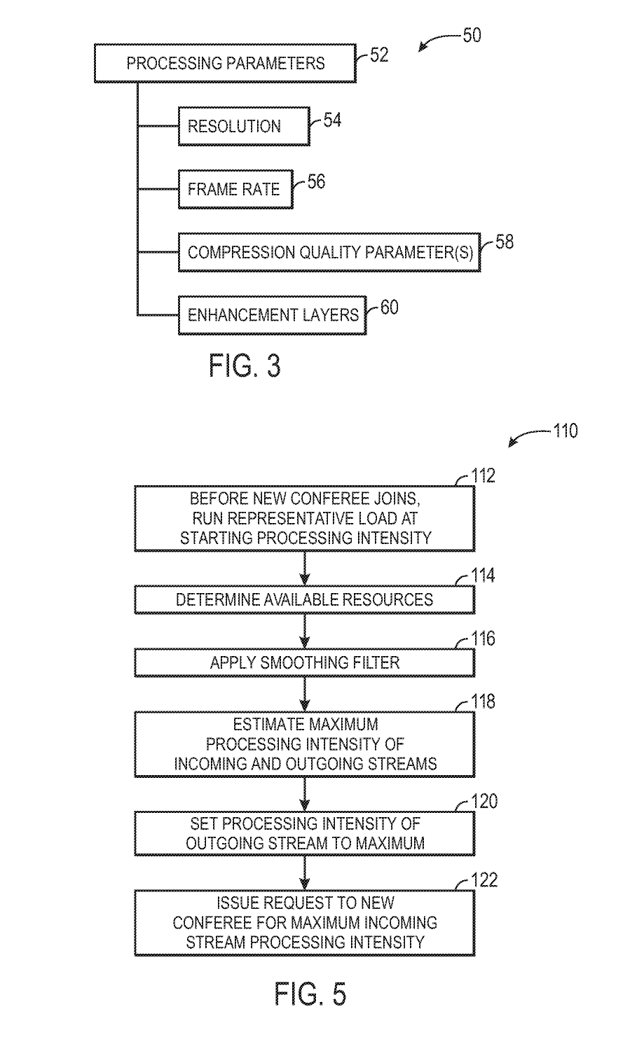

The resource manager component 42 of the video conferencing component 36 may adjust a variety of factors in the compressor component 38. For example, a parameter diagram 50 of FIG. 3 represents various processing parameters 52 that may be adjusted to increase or decrease the processing intensity of the outgoing media stream 24, and which may be requested in the incoming processing intensity request 44 to cause other conferencing devices 12 to change the processing intensity 22 of the incoming media streams 20.

Such processing parameters 52 may include a first parameter 54, adjusting the resolution of the outgoing media stream 24. In particular, a higher resolution video stream in the outgoing media stream 24 may require more resources to compress in the compressor component 38 and more resources to decompress in the decompressor component 40. Thus, to lower the resource consumption of the video conferencing device 12, the resource manager component 42 may cause the resolution of the outgoing media stream 24 to be lowered or issue a request for the resolution of the incoming media stream 20 to be lowered.

A second parameter 56 of the processing parameters 52 may be a frame rate of video data of the outgoing media stream 24 or the incoming media stream 20. Although a higher frame rate of the outgoing media stream 24 may produce smoother video, the higher the frame rate, the greater the resources used by the compressor component 38 to compress the outgoing media stream 24 and to decompress the incoming media stream 20 using the decompressor component 40. Thus, to lower the resource consumption of the video conferencing device 12, the resource manager component 42 may cause the frame rate of the outgoing media stream 24 to be lowered or issue a request for the frame rate of the incoming media stream 20 to be lowered.

A third parameter 58 of the processing parameters 52 may be a compression quality parameter (QP). In general, the higher the compression quality parameter during compression via the compressor component 40 of the video conferencing component 36, the lower the resource processing intensity (but also the higher the bandwidth). Thus, if the bandwidth is available, adjusting the compression quality parameters may be an effective manner of adjusting the processing intensity 22 of the incoming media streams 20 and the processing intensity 26 of the outgoing media stream 24.

A fourth parameter 60 of the processing parameters 52 may be the number of enhancement layers employed by the compressor component 38 of the video conferencing component 36. For example, when the compressor component 38 uses three enhancement layers rather than two, the processing intensity 26 of the outgoing media stream 24 may be higher. Likewise, when the incoming media stream 20 includes, for example, three enhancement layers rather than two, the processing intensity 22 to decompress the incoming media stream 20 using the decompressor component 40 may increase.

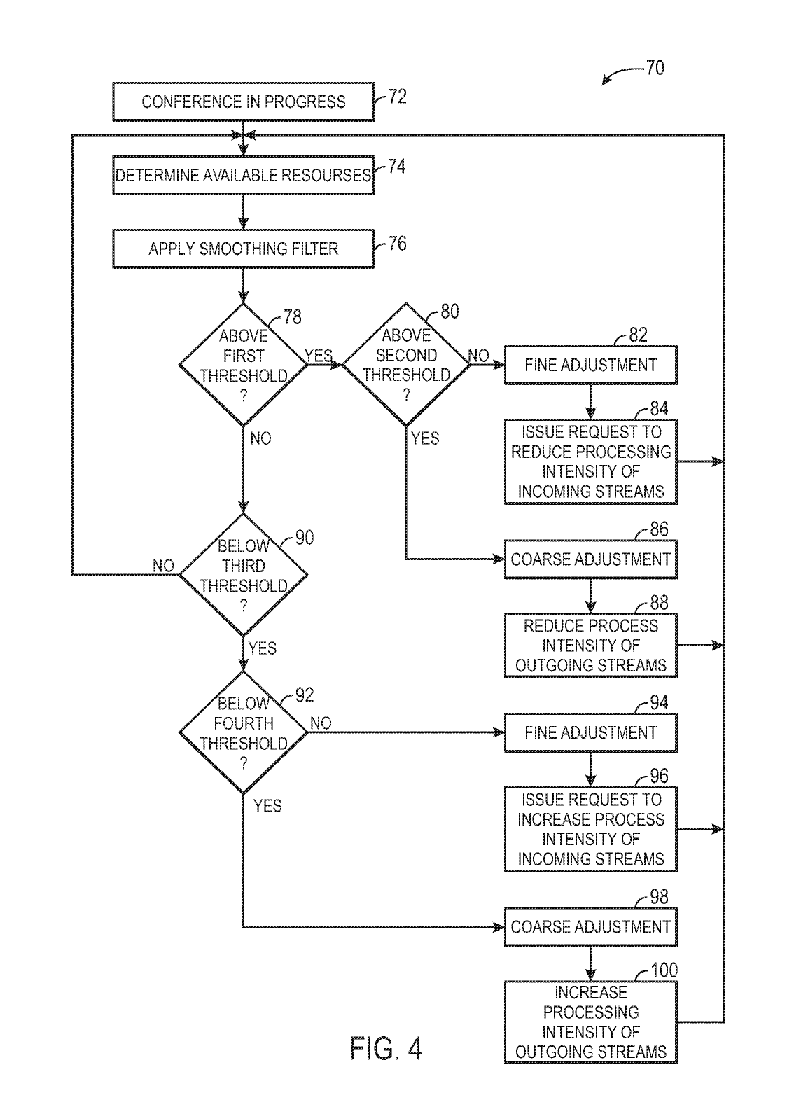

The resource manager component 42 may adjust the performance of the compressor component 38 and the decompressor component 40 according to a variety of different manners. One method of controlling the performance of the compressor component 38 and the decompressor component 40 appears in a flowchart 70 of FIG. 4. The flowchart 70 may begin when the video conferencing component 36 of the video conferencing device 12 is currently participating in a video conference (block 72). Periodically, the video conferencing component 36 may measure the available resources of the video conferencing device 12 (e.g., processing load, available memory, battery life, available storage, and so forth) (block 74). For example, in one embodiment, the video conferencing component 36 may sample the current load of the processor(s) 28 of the video conferencing device 12. That is, the video conferencing component 36 may query the operating system of the video conferencing device 12 for the CPU load, for example, approximately every 500 ms. To avoid thrashing, a smoothing filter may be applied to the measure of available resources (block 76). Any suitable filter may be applied, including, for example, a weighted average over the previous 5, 10, 20, or 50 samples, for example.

If the filtered measure of available resources that are in use exceeds a first threshold (e.g., 90%), which may represent an amount of resources in use that approaches resource usage that is expected to cause overloading (decision block 78), but does not exceed a second threshold (e.g., some threshold greater than 90%) (decision block 80), the resource manager component 42 of the video conferencing component 36 may undertake a “fine adjustment” (block 82). That is, the resource manager component 42 may cause the video conferencing device 12 to issue an incoming processing intensity request 44 to the other video conferencing devices 12 with which it is communicating to reduce the processing intensity 22 of the incoming media streams 20 (block 84). For example, the incoming processing intensity request 44 may cause the incoming media streams 20 to have a lower frame rate or resolution in some embodiments. In certain embodiments, when sufficient bandwidth is available, the incoming media stream 20 may be of a higher quality with less compression, thereby requiring less processing intensive decompression by the decompressor component 40. Thereafter, the video conferencing component 36 may continue to determine the available resources (block 74) and apply the filter (block 76).

If the filtered measure of available resources that are in use is above the first threshold (decision block 78), and also above the second threshold (decision block 80), the resource manager component 42 may undertake a “coarse adjustment” to curtail resource consumption (block 86). That is, the resource manager component 42 of the video conferencing component 36 may cause the compressor component 38 to compress video data from the camera 14 using less processing intensive parameters (block 88). Specifically, in some embodiments, the resource manager component 42 may adjust the processing parameters 52 discussed above with reference to FIG. 3, causing the compression of the outgoing media stream 24 to consume less resources and the outgoing media stream 24 to have a lower processing intensity 26. Thereafter, the video conferencing component 36 may continue to determine the available resources (block 74) and apply the filter (block 76).

If the filtered measure of available resources that are in use is below the first threshold (e.g., 90%) (decision block 78), but above a third threshold (e.g., 70%) (decision block 90), the resource manager component 42 may not change the operation of the video conferencing component 36. However, if the filtered measure of available resources that are in use is below the first threshold (decision block 78) and below the third threshold (decision block 90), the resource manager component 42 may increase the processing intensity 26 of the outgoing media stream 24 or the processing intensity 22 of the incoming media stream 20. Specifically, if the filtered measure of available resources that are in use is not below a fourth threshold (e.g., some threshold lower than 70%) (decision block 92), the resource manager component 42 of the video conferencing component 36 may undertake a “fine adjustment” (block 94). That is, the resource manager component 42 may cause the video conferencing device 12 to issue an incoming processing intensity request 44 to the other video conferencing devices 12 with which it is communicating to increase the processing intensity 22 of the incoming media streams 20 (block 96). For example, the incoming processing intensity request 44 may cause the incoming media streams 20 to have a higher frame rate or resolution in some embodiments. In certain embodiments, to conserve bandwidth, the incoming media stream 20 may be of a lower quality with higher compression, which may require more processing intensive decompression by the decompressor component 40. Thereafter, the video conferencing component 36 may continue to determine the available resources (block 74) and apply the filter (block 76).

If the filtered measure of available resources that are in use is below the fourth threshold (decision block 92), the resource manager component 42 of the video conferencing component 36 may undertake a “coarse adjustment” to significantly increase resource consumption (block 98). That is, the resource manager component 42 of the video conferencing component 36 may cause the compressor component 38 to compress video data from the camera 14 using more processing intensive parameters (block 100). The resource manager component 42 may adjust the processing parameters 52 discussed above with reference to FIG. 3, causing the compression of the outgoing media stream 24 to consume more resources and the outgoing media stream 24 to have a higher processing intensity 26. Thereafter, the video conferencing component 36 may continue to determine the available resources (block 74) and apply the filter (block 76).

In addition to adjusting the resource consumption of the video conferencing component 36 of the video conferencing device 12, the resource manager component 42 may also select certain initial parameters to ensure a reasonable load on the video conferencing device 12. One embodiment of doing so is shown in a flowchart 110 of FIG. 5. The flowchart 110 may begin before the start of a video conference or before a new conferee joins a video conference. Specifically, the video conferencing component 36 may run a representative test load on the video conferencing device 12 at a set of starting processing intensity values (block 112), That is, the compressor component 38 may run a test load, compressing sample video data at an initial processing intensity 26. Likewise, the decompressor component 40 may decompress a sample video stream having an initial processing intensity 22. While the representative load is running, the load on the processor(s) 28 may be sampled (block 114) and any suitable smoothing filter may be applied (block 116), in a manner such as that discussed above with reference to FIG. 4.

Based on the load on the processor(s) 28, the video conferencing component 36 may estimate maximum processing intensities 26 and 22 that would permit a reasonable bad to be running on the processor(s) 28 (block 118). The resource manager component 42 of the video conferencing component 36 may initialize the processing intensity 26 of the outgoing media stream 24 output by the compressor component 38 to such an estimated maximum (block 120). Likewise, the resource manager component 42 of the video conferencing component 36 may cause the video conferencing device 12 to issue incoming processing intensity requests 44 for the estimated maximum processing intensity to other video conferencing devices 12 that are or will appear in the video conference (block 122).

Technical effects of the disclosure include enabling video conferences on an electronic device in a manner that avoids erratic operation due to system overloading. Thus, some embodiments may allow optimized compression and/or decompression of video conferencing data without overloading the electronic device. Not only is the processing intensity of the outgoing media streams optimized by adjusting certain parameters associated with video compression (e.g., resolution, frame rate, quality parameter, enhancement layers, etc.), but the processing intensity of the incoming media streams is optimized as well by issuing requests to the other video conferencing devices that provide such streams.

1. An electronic device (12) comprising:
data processing circuitry (28) configured to:
compress first video data from a camera (14) associated with the electronic device (12) using first processing parameters to obtain a compressed outgoing video stream (24);
decompress a compressed incoming video stream (20) to obtain second video data, wherein the compressed incoming video stream (20) represents second video data compressed by a second electronic device (12) using second processing parameters;
measure a load on the data processing circuitry (28); and
when the load on the data processing circuitry (28) approaches a load that is expected to cause overloading, prevent the overloading by selectively either adjusting the first processing parameters to cause compressing the first video data to consume fewer resources or issuing a first outgoing request to the second electronic device (12) to adjust the second processing parameters such that decompressing the first incoming video stream (20) consumes fewer resources, or by adjusting the first processing parameters to cause compressing the first video data to consume fewer resources and issuing the first outgoing request;
an electronic display (16) configured to display the second video data; and
a network interface (34) configured to receive the incoming video stream (20) from the second electronic device (12) and to transmit the outgoing video stream (24) and the first request to the second electronic device (12).

2. The electronic device (12) of claim 1, wherein the data processing circuitry (28) is configured to prevent the overloading by adjusting the first processing parameters to cause compressing the first video data to consume fewer resources, wherein adjusting the first processing parameters to cause compressing the first video data to consume fewer resources comprises reducing a resolution of the first video data, reducing a frame rate of the first video data, reducing a number of enhancement layers, or increasing a compression quality parameter, or any combination thereof.

3. The electronic device (12) of claim 1, wherein the data processing circuitry (28) is configured to prevent the overloading by issuing the first outgoing request when the load on the data processing circuitry (28) exceeds a first threshold but not a second threshold and by adjusting the first processing parameters to cause compressing the first video data to consume fewer resources when the load on the data processing circuitry (28) exceeds the second threshold, wherein the second threshold is greater than the first threshold.

4. The electronic device (12) of claim 1, wherein the data processing circuitry (28) is configured, when the load on the data processing circuitry (28) does not approach a load that is expected to cause overloading, to increase the load by selectively adjusting the first processing parameters to cause compressing the first video data to consume more resources or issuing a second outgoing request to the second electronic device (12) to adjust the second processing parameters such that decompressing the incoming video stream (20) consumes more resources, or by adjusting the first processing parameters to cause compressing the first video data to consume more resources and issuing the second outgoing request.

5. The electronic device (2) of claim 4, wherein the data processing circuitry (28) is configured to increase the load by issuing the second outgoing request when the load on the data processing circuitry (28) is beneath a third threshold but not a fourth threshold and by adjusting the first processing parameters to cause compressing the first video data to consume more resources when the load on the data processing circuitry (28) is beneath the fourth threshold, wherein the fourth threshold is lower than the third threshold.

6. The electronic device (12) of claim 1, wherein the network interface (34) is configured to receive an incoming request from the second electronic device (12) to adjust the first processing parameters and wherein the data processing circuitry (28) is configured to adjust the first processing parameters in response to the incoming request.

7. The electronic device (2) of claim 1, wherein the network interface (34) is configured to communicate with the second electronic device (12) via a peer-to-peer connection.

8. An article of manufacture comprising:
one or more tangible, machine-readable media (30, 32) at least collectively having instructions encoded thereon for execution by a processor (28) of an electronic device (12), the instructions comprising:
instructions to determine a measure of available resources of the electronic device (12) that are in use;
instructions to reduce, when the measure of available resources is above a first threshold and a second threshold, a first frame rate or a first resolution or both the first frame rate and the first resolution of an outgoing video stream (24) being compressed by a video compressor component (38) of the electronic device (12), such that when the video compressor component (38) compresses the outgoing video stream (24), the available resources of the electronic device (12) are increased; and
instructions to cause, when the measure of available resources is above the first threshold but not the second threshold, a second electronic device (12) providing an incoming video stream (20) at a second frame rate and a second resolution to a decompressor component (40) of the electronic device (12) to reduce the second frame rate or the second resolution or both the second frame rate and the second resolution, such that when the decompressor component (40) decompresses the incoming video stream (20), the available resources of the electronic device (12) are increased.

9. The article of manufacture of claim 8, wherein the instructions to determine the measure of available resources that are in use comprise instructions to determine a load on the processor (28) of the electronic device (12), available memory of the electronic device (12), remaining battery power of the electronic device (12), or remaining storage capacity, or any combination thereof.

10. The article of manufacture of claim 8, comprising instructions to increase, when the measure of available resources is below a third threshold and a fourth threshold, the first frame rate or the first resolution or both the first frame rate and the first resolution, such that when the video compressor component (38) compresses the outgoing video stream (24), the available resources of the electronic device (12) are decreased.

11. The article of manufacture of claim 10, comprising instructions to cause, when the measure of available resources is below the third threshold but not the fourth threshold, the second electronic device (12) to reduce the second frame rate or the second resolution or both the second frame rate and the second resolution, such that when the decompressor component (40) decompresses the incoming video stream (20), the available resources of the electronic device (12) are decreased.

12. The article of manufacture of claim 8, wherein the instructions to cause the second electronic device (12) to reduce the second frame rate or the second resolution or both the second frame rate and the second resolution comprise instructions to transmit a request to the second electronic device (12) via a network interface (34) of the electronic device (12) to reduce the second frame rate or the second resolution or both the second frame rate and the second resolution.

13. The article of manufacture of claim 8, wherein the instructions to reduce the first frame rate or the first resolution or both the first frame rate and the first resolution of the outgoing video stream (24) cause the available resources of the electronic device (12) to be increased when the video compressor component (38) compresses the outgoing video stream (24), wherein the video compressor component (38) is a hardware component of the electronic device (12) distinct from the processor (28) of the electronic device (12).

14. The article of manufacture of claim 8, wherein the instructions to reduce the first frame rate or the first resolution or both the first frame rate and the first resolution of the outgoing video stream (24) cause the available resources of the electronic device (12) to be increased when the video compressor component (38) compresses the outgoing video stream (24), wherein the video compressor component (38) is a component of machine readable instructions being executed by the processor (28) of the electronic device (12).

15. A video conferencing system (12) comprising:
a camera (14) configured to obtain first video data;
data processing circuitry (28) configured to:
compress the first video data according to first parameters to obtain an outgoing video stream (24);
decompress an incoming video stream (20) that has been compressed by a remote video conferencing system (12) according to second parameters; and
manage an initial load on the processing circuitry occurring when a video conference with the remote video conferencing system (12) begins by determining the first parameters and the second parameters before the remote video conferencing system (12) begins to provide the incoming video stream (20); and
a network interface (34) configured to transmit an indication of the second parameters to the remote video conferencing system (12) before the video conference with the remote video conferencing system (12) begins, and receive the incoming video stream (20) from the remote video conferencing system (12) and transmit the outgoing video stream (24) when the video conference with the remote video conferencing system (12) begins.
